(19) United States
(12) Patent Application Publication
(10) Pub. No.: US 2025/0049160 A1
(43) Pub. Date: Feb. 13, 2025

(54) ONE-TIME MOLDED FALSE EYELASH AND PREPARATION AND WEARING METHODS THEREOF

(71) Applicant: QINGDAO KELLY LASH COSMETIC CO.,LTD., Qingdao (CN)

(72) Inventor: Simin SUN, Qingdao (CN)

(21) Appl. No.: 18/934,109

(22) Filed: Oct. 31, 2024

(30) Foreign Application Priority Data
Oct. 17, 2024 (CN) 202411455537.7

(51) Int. Cl. A41G 5/02; B29C 69/00; B29L 31/00

(52) U.S. Cl. CPC A41G 5/02; B29C 69/001; B29C 2793/0081; B29L 2031/718

(57) ABSTRACT

Provided are a one-time molded false eyelash and preparation and wearing methods thereof. The preparation method comprises the following steps: S1: selecting a sheet-shaped film material as a base material, and cutting the base material into filaments according to preset parameters by a laser cutting device to form a single-sheet eyelash or an integrally molded semi-finished eyelash; S2: when the single-sheet eyelash is formed by cutting, combining and fixing two single-sheet eyelashes to obtain semi-finished products with different styles; and S3: placing the semi-finished product in a pressure plastic shaping device, and applying a pressure to semi-finished eyelash filaments by the pressure plastic shaping device, so that the semi-finished eyelash filaments are bent and shaped to obtain the false eyelash.

### CROSS-REFERENCE TO RELATED APPLICATIONS

This application claims foreign priority of Chinese Patent Application No. 202411455537.7, filed on Oct. 17, 2024 in the China National Intellectual Property Administration, the disclosures of all of which are hereby incorporated by reference.

### TECHNICAL FIELD

The present invention relates to the technical field of cosmetics, and particularly to a one-time molded false eyelash and preparation and wearing methods thereof.

BACKGROUND OF THE PRESENT INVENTION

False eyelash is a cosmetic product, which is adhered to a real eyelash to improve the beauty of eyes. Sectional self-grafting eyelash is a repeatedly used false eyelash that does not need to be worn and removed every day, and compared with traditional eyelashes, this false eyelash is more economical and environmentally friendly, and is more widely applied.

At present, the sectional self-grafting false eyelash has many shortcomings: 1.most of the existing false eyelashes are made of finished eyelash filaments through the processes of adhering, gluing, cutting, heating shaping, and the like, which have complex technology, low efficiency, high production cost and long preparation procedure; 2. whether the eyelash filaments of the existing false eyelashes are fixed by a thread-shaped, film-shaped or glued stalk, the eyelash filaments and the eyelash stalk are physically connected, so the service life of the product is short and the wearing comfort is poor; and 3. at present, the eyelash filaments are usually bent and shaped by heating bending, the shaping method of heating bending is easy to cause burns and other safety problems, and the shaping efficiency is low, and at the same time, the heating is easy to affect the physical and chemical properties of materials, such as strength and hardness, thus affecting the quality of the finished product, so that when the existing false eyelashes are worn, the requirements for the glue for grafting and the glue application method are high, and the wearing is laborious.

### SUMMARY OF THE PRESENT INVENTION

In order to solve the problems in the background, the present invention provides a preparation method of a one-time molded false eyelash, which comprises the following steps:

S1: Selecting a sheet-shaped film material as a base material, and cutting the base material into filaments according to preset parameters by a laser cutting device to form a single-sheet eyelash;

S2: when the single-sheet eyelash is formed by cutting, combining and fixing two single-sheet eyelashes to obtain semi-finished products with different styles; and

S3: placing the semi-finished eyelash in a pressure plastic shaping device, and applying a pressure to semi-finished eyelash filaments by the pressure plastic shaping device, so that the semi-finished eyelash filaments are bent and shaped to obtain the false eyelash.

Preferably, the single-sheet eyelash comprises a single-sheet eyelash root connecting stalk and a plurality of single-sheet eyelash filaments which are integrally molded, the single-sheet eyelash filaments are located on one side of the single-sheet eyelash root connecting stalk, and the single-sheet eyelash root connecting stalk is straight-shaped, arc-shaped or wave-shaped.

Preferably, at least two single-sheet grafting posts are arranged on one side of the single-sheet eyelash root connecting stalk far away from the single-sheet eyelash filaments, and the single-sheet grafting posts and the single-sheet eyelash root connecting stalk are integrally molded.

Preferably, the pressure plastic shaping device applies the pressure to the semi-finished eyelash filaments by rolling shaping and stamping shaping.

Preferably, the pressure plastic shaping device comprises a stamping shaping device, the stamping shaping device comprises a frame, a controller, an air cylinder control valve, an air source, a stamping air cylinder, an air source processor and an object carrier, the stamping air cylinder is fixed on the frame, a telescopic end of the stamping air cylinder is fixed with a shaping plate, the object carrier is located on one side of the telescopic end of the stamping air cylinder, the object carrier is fixed relative to the frame, the object carrier is provided with a shaping groove corresponding to a position of the shaping plate, the stamping air cylinder is connected with the air cylinder control valve through an air pipe, the air cylinder control valve is connected with an output end of the air source processor through an air pipe, an input end of the air source processor is connected with the air source through an air pipe, and the controller is electrically connected with the air cylinder control valve and the air source processor respectively.

Preferably, the step S3 specifically comprises: placing the semi-finished eyelash on the object carrier, so that the semi-finished eyelash filaments are located on the shaping groove, starting up the stamping air cylinder, driving, by the telescopic end of the stamping air cylinder, the shaping plate to move towards the shaping groove, pressing, by the shaping plate, the semi-finished eyelash filaments into the shaping groove, after each pressing by the shaping plate, driving, by the telescopic end of the stamping air cylinder, the shaping plate to retract, moving the semi-finished eyelash filaments in a length direction of the eyelash filaments once, so that a non-pressed part of the semi-finished eyelash filaments is located in the shaping groove, driving, by the stamping air cylinder, the shaping plate to press again, pressing the non-pressed part of the semi-finished eyelash filaments into the shaping groove, and repeating in this way to realize sectional cold stamping of the semi-finished eyelash filaments, so that the semi-finished eyelash filaments are bent and shaped.

Preferably, the pressure plastic shaping device comprises a rolling shaping device, the rolling shaping device comprises a roller and a covering structure, an outer wall of the roller is provided with a plurality of pointed protrusions, the plurality of pointed protrusions cover the outer wall of the roller, the semi-finished eyelash is roll-molded by the rolling shaping device, and a roll molding method comprises: wrapping the semi-finished eyelash on the outer wall of the roller by the covering structure, so that the semi-finished eyelash is bent in a circumferential direction of the roller, and after wrapping, rolling the roller wrapped with the semi-finished eyelash and the covering structure on a workbench, and pressing the roller while rolling.

Preferably, the rolling shaping device further comprises a first base, a support and a first air cylinder, the support is fixed on the first base, the first air cylinder is fixed on the support, a telescopic end of the first air cylinder extends downwards and is fixed with a roller mounting frame, two ends of the roller are rotatably connected with the roller mounting frame through a rotating shaft, and a space is maintained between an end portion of the roller and the roller mounting frame;
the covering structure comprises a semi-cylindrical shell, the semi-cylindrical shell is located below the roller, two ends of the semi-cylindrical shell are respectively fixed with a baffle, an upper portion of the baffle is provided with a placing groove with a semi-circular bottom end, and one side of the baffle far away from the semi-cylindrical shell is fixed with an arc-shaped slider;
two ends of the semi-cylindrical shell on the first base are respectively fixed with an elastic telescopic rod, a top portion of the elastic telescopic rod is fixed with a semi-circular slide rail, and the arc-shaped slider is slidably arranged in the semi-circular slide rail;
the arc-shaped slider, the semi-circular slide rail, the semi-cylindrical shell and a semi-circular end of the placing groove are coaxially arranged, an axis of the semi-cylindrical shell and an axis of the roller are located in a same vertical plane, and the semi-cylindrical shell is located below the roller; and
a slide plate is slidably arranged on the first base, the slide plate is located below the semi-cylindrical shell, the slide plate is driven by a second air cylinder, and a top surface of the slide plate is the workbench.

Preferably, the step S3 specifically comprises: placing the semi-finished eyelash in the semi-cylindrical shell, starting up the first air cylinder, driving, by the first air cylinder, the roller to move downwards, so that a lower portion of the roller enters the semi-cylindrical shell, allowing the rotating shaft to enter the placing groove and the semi-circular slide rail at the same time, and after the roller and the semi-cylindrical shell are coaxial, wrapping the semi-finished eyelash on the outer wall of the roller under a squeezing action of the roller and the semi-cylindrical shell; and continuously driving, by the first air cylinder, the roller to move downwards, driving, by the roller, the semi-cylindrical shell to move downwards at this time, compressing the elastic telescopic rod, after the semi-cylindrical shell makes contact with the top surface of the slide plate and applies a pressure on the slide plate, stopping the first air cylinder, starting up the second air cylinder, allowing the second air cylinder to repeatedly extend and retract to drive the slide plate to slide back and forth, and driving, by the slide plate, the semi-cylindrical shell and the roller to rotate back and forth, so as to realize the rolling pressing on the semi-finished eyelash, so that the semi-finished eyelash filaments are bent and shaped.

A one-time molded false eyelash is provided, wherein the false eyelash comprises an integrally molded eyelash filament, an eyelash stalk and a grafting post, a plurality of eyelash filaments are provided, the plurality of eyelash filaments are located on one side of the eyelash stalk, the grafting post is located on the other side of the eyelash stalk, and at least two grafting posts are provided.

A wearing method of the one-time molded false eyelash is provided, wherein, when wearing, glue for eyelash grafting is coated on the grafting post and/or the eyelash stalk, then the grafting post and/or the eyelash stalk are adhered to a real eyelash, and the false eyelash is located above or below the real eyelash.

The present invention has the beneficial effects as follows.

1. According to the present invention, the false eyelash is prepared by laser cutting, and the eyelash filaments and the eyelash stalk are integrally molded, so that the preparation procedures are reduced, the preparation efficiency is improved, and the eyelash filaments and the eyelash stalk do not need secondary connection, thus realizing higher wearing comfort.

2. According to the present invention, the eyelash filaments are bent and molded by stamping or rolling, and compared with the traditional heating bending method, the stamping bending and the rolling bending have less influence on the properties of materials, and the stamping and rolling bending operations are simple and convenient, and have higher safety and molding efficiency.

3. According to the present invention, the false eyelash is more simple and convenient to wear, the glue for grafting is coated on the grafting posts when wearing, and then the grafting posts are adhered to the real eyelash, so that the false eyelash is convenient to wear and has good adhering effect.

4. The preparation method of laser cutting can realize the preparation of arc-shaped eyelash stalk, and the arc-shaped eyelash stalk is more suitable for a human eyelid, thus having better wearing effect and higher comfort.

### DESCRIPTION OF THE DRAWINGS

FIG. 1 is a flow chart of a preparation method of the present invention;

FIG. 2 is a first schematic diagram of an overall structure of a stamping shaping device of the present invention;

FIG. 3 is a second schematic diagram of the overall structure of the stamping shaping device of the present invention;

FIG. 4 is an enlarged view of a structure at a part A in FIG. 1;

FIG. 5 is a schematic diagram of an overall structure of a rolling shaping device of the present invention;

FIG. 6 is an enlarged view of a structure at a part B in FIG. 4;

FIG. 7 is a radial section view of a semi-cylindrical shell of the present invention;

FIG. 8 is a schematic structural diagram of a single-sheet eyelash with a straight-shaped single-sheet eyelash root connecting stalk of the present invention;

FIG. 9 is a schematic structural diagram of a single-sheet eyelash with an arc-shaped single-sheet eyelash root connecting stalk of the present invention; and

FIG. 10 is a schematic structural diagram of a semi-finished eyelash of the present invention.

Reference numerals in the drawings: 1 refers to second base; 2 refers to controller; 3 refers to frame; 4 refers to stamping air cylinder; 5 refers to shaping plate; 6 refers to air cylinder control valve; 7 refers to air source processor; 8 refers to object carrier; 9 refers to shaping groove; 10 refers to shaping tip; 11 refers to slide rail; 12 refers to slider; 13 refers to fixing plate; 14 refers to mounting plate; 15 refers to support; 16 refers to first air cylinder; 17 refers to roller mounting frame; 18 refers to roller; 19 refers to semi-cylindrical shell; 191 refers to lightweight material; 192 refers to heavyweight material; 193 refers to baffle; 20 refers to elastic telescopic rod; 21 refers to slide plate; 22 refers to second air cylinder; 23 refers to first base; 24 refers to guide rod; 25 refers to placing groove; 26 refers to semi-circular slide rail; 27 refers to blocking sheet; 28 refers to arc-shaped slider; 29 refers to flexible material layer; 30 refers to rotating shaft; 31 refers to single-sheet eyelash filament; 32 refers to single-sheet eyelash root connecting stalk; 33 refers to single-sheet grafting post; 34 refers to semi-finished eyelash filament; 35 refers to semi-finished eyelash stalk; and 36 refers to grafting post.

### DETAILED DESCRIPTION OF PREFERRED EMBODIMENTS

In order to make the present invention more clear and understandable, the technical solution of the present invention is further described in detail hereinafter with reference to the drawings and embodiments, and it should be understood that the given embodiment is only one of the implementations and does not represent all the embodiments.

The terms “up, down, inside, outside” and the like herein are established based on the positional relationship shown in the drawings, and the corresponding positional relationship may change according to different drawings, so they cannot be understood as absolute limitations on the scope of protection.

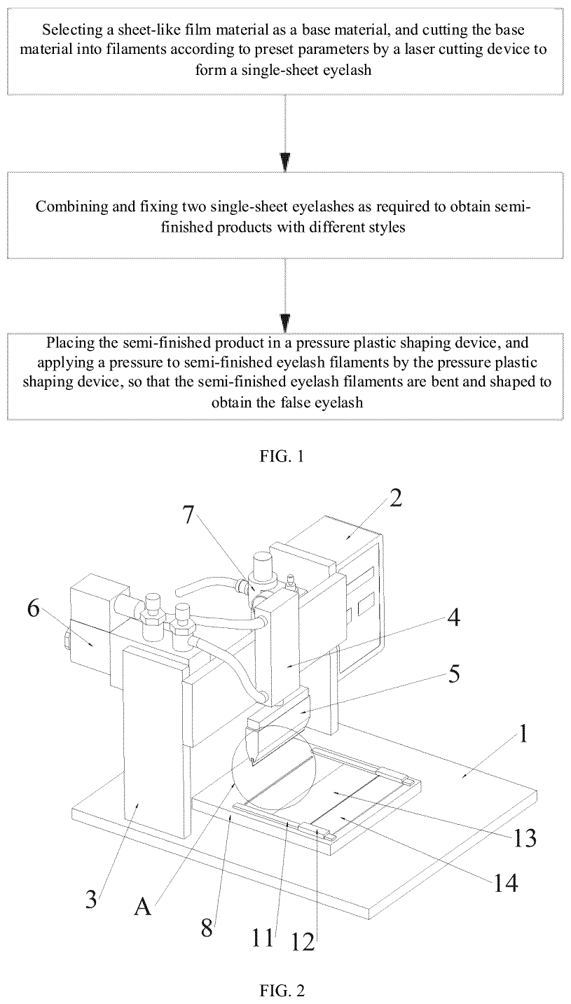

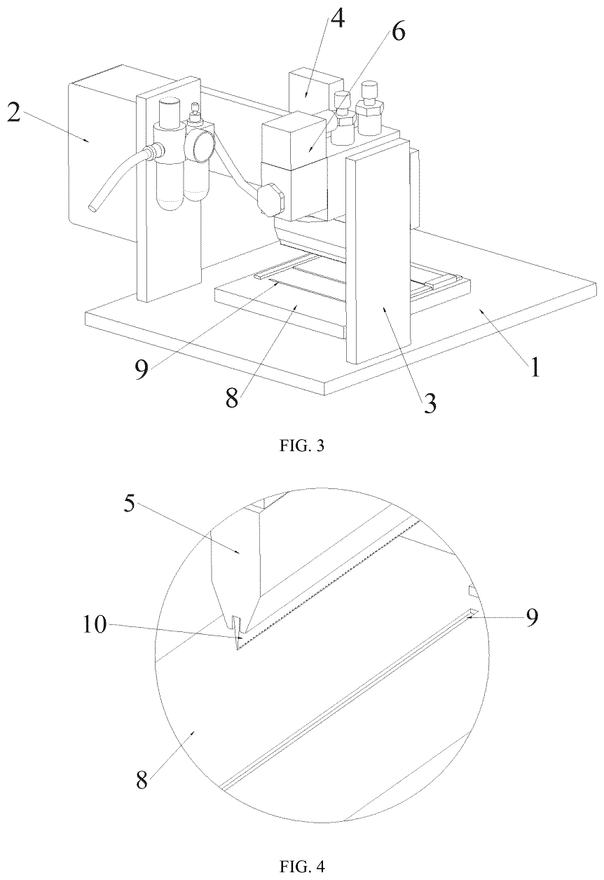

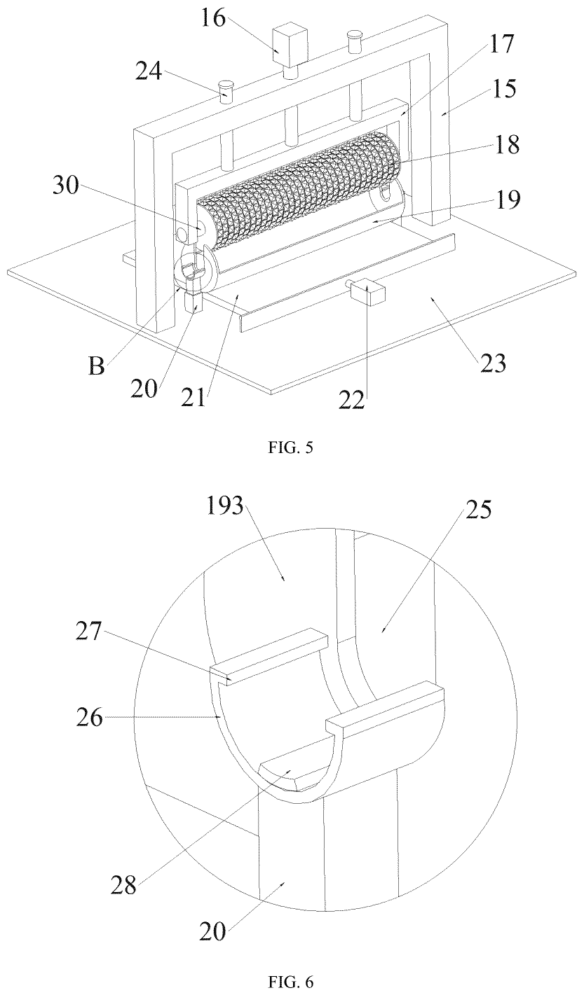

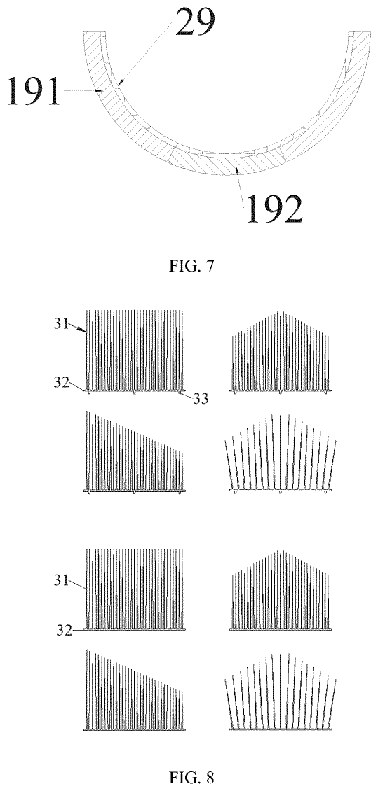

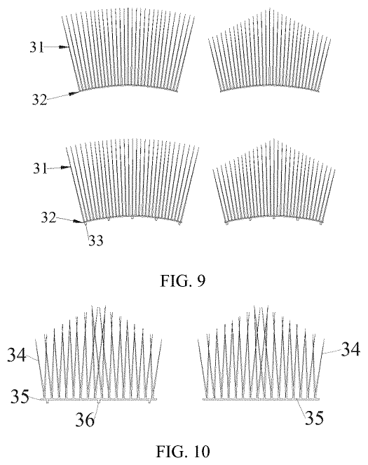

With reference to FIG. 1 to FIG. 10, a preparation method of a one-time molded false eyelash comprises the following steps.

In S1, a sheet-shaped film material is selected as a base material, wherein the base material is a plastic or polyester material, and the base material is cut into filaments according to preset parameters by a laser cutting device to form a single-sheet eyelash or an integrally molded semi-finished eyelash.

Specifically, the step S1 is as follows.

In S11, the material is prepared:

(1) it is ensured that the base material is flat and wrinkle-free, and a thickness of the base material meets the design requirement; and

(2) a surface of the base material is cleaned to remove pollutants such as dust. In S12, a drawing is designed:

(1) the design drawing of required single-sheet eyelash or semi-finished eyelash is created by CAD software; and

(2) parameters such as a size and a shape in the drawing are adjusted according to the actual demand.

In S13, the drawing is imported:

the designed drawing is imported into control software provided for a laser cutting device.

In S14, device parameters are adjusted:
parameters such as laser power, speed and frequency are set, these parameters are determined according to the thickness of the base material and required cutting quality; and
in order to ensure the accurate adjustment of the parameters and avoid wasting the material at the same time, a cutting effect may be tested on a waste material to adjust the parameters to the best state; and generally, the power is set to be 1 watt to 100 watts, and the cutting speed is set to be 1 mm to 8000 mm per second.

In S15, the material is fixed:

the base material is fixed on a workbench by a fixture or vacuum adsorption to ensure that the base material will not move during cutting.

In S16, the cutting is started:

after checking the device settings, the laser cutting device starts to cut.

In S17, a process is monitored:

a working state of device is monitored in the cutting process, and if there is any abnormality, the operation is immediately stopped to check the reason.

In S18, post-treatment is finished:

after cutting, the cut film sheet is removed to check whether there is a burr or an incompletely cut part; and

if there is the burr or the incompletely cut part, subsequent processing such as edge grinding or secondary cutting may be carried out.

Different types of laser cutting devices may be selected for laser cutting of the film sheet, and the selectable laser cutting devices comprise, but are not limited to, a CO₂ laser device, an ultraviolet laser device, a picosecond laser device and a femtosecond laser device.

In S2, when the single-sheet eyelash is formed by cutting, two single-sheet eyelashes are combined and fixed as required to obtain semi-finished products with different styles.

Specifically, the single-sheet eyelash comprises a single-sheet eyelash root connecting stalk 32 and a plurality of single-sheet eyelash filaments 31 which are integrally molded, the single-sheet eyelash filaments 31 are located on one side of the single-sheet eyelash root connecting stalk 32, and the single-sheet eyelash root connecting stalk 32 is straight-shaped, arc-shaped or wave-shaped.

More specifically, an included angle between the single-sheet eyelash filaments 31 and the single-sheet eyelash root connecting stalk 32 is 1° to 90°, that is, the single-sheet eyelash filaments 31 may be perpendicular to the single-sheet eyelash root connecting stalk 32 or inclined to the single-sheet eyelash root connecting stalk 32, and the included angle is preferably 30° to 90°. The plurality of single-sheet eyelash filaments 31 may be sequentially arranged singly along the single-sheet eyelash root connecting stalk 32, or may be sequentially arranged in clusters along the single-sheet eyelash root connecting stalk 32, with at least two single-sheet eyelash filaments 31 as one cluster. An arrangement shape of the plurality of single-sheet eyelash filaments 31 on each single-sheet eyelash root connecting stalk 32 may be set as required, that is, the single-sheet eyelash filaments 31 may be arranged in different shapes, such as a fan and a right-angled trapezoid, by setting an inclination angle and a length of each single-sheet eyelash filament 31.

Specifically, at least two single-sheet grafting posts 33 are arranged on one side of the single-sheet eyelash root connecting stalk 32 far away from the single-sheet eyelash filaments 31, and the single-sheet grafting posts 33 and the single-sheet eyelash root connecting stalk 32 are integrally molded.

Specifically, two single-sheet eyelashes are adhered together by glue or an adhesive tape to realize the combination and fixation. For the combined two single-sheet eyelashes, both of the single-sheet eyelashes may be provided with the single-sheet grafting posts 33, both of the single-sheet eyelashes may be not provided with single grafting posts 33, and one of the single-sheet eyelashes is provided with the single grafting posts 33 while the other of the single-sheet eyelashes is not provided with the single grafting posts 33. When one of the combined two single-sheet eyelashes is provided with the single grafting posts 33 while the other of the combined single-sheet eyelashes is not provided with the single grafting posts 33, the formed eyelash is a semi-finished eyelash with grafting posts 36.

Compared with the semi-finished eyelash formed by combining the two single-sheet eyelashes, the semi-finished eyelash integrally molded by laser cutting directly has the same overall structure. However, compared with the integrally molded semi-finished eyelash, when the two single-sheet eyelashes are combined, the single-sheet eyelash filaments 31 of the two single-sheet eyelashes are not in the same plane, and the single-sheet eyelash filaments 31 of the two single-sheet eyelashes may not be adhered to each other, so that the formed semi-finished eyelash has better stereoscopic effect and visual effect.

It should be understood that FIG. 8 to FIG. 10 show schematic structural diagrams of several single-sheet eyelashes and semi-finished eyelashes, and the given eyelash structures are only examples, which do not represent all shapes of eyelashes.

In S3, the semi-finished eyelash is placed in a pressure plastic shaping device, and a pressure is applied to semi-finished eyelash filaments 34 by the pressure plastic shaping device, so that the semi-finished eyelash filaments 34 are bent and shaped to obtain the false eyelash.

Specifically, the pressure plastic shaping device applies the pressure to the semi-finished eyelash filaments 34 by rolling shaping and stamping shaping.

Specifically, the pressure plastic shaping device comprises a stamping shaping device, the stamping shaping device comprises a frame 3, a controller 2, an air cylinder control valve 6, an air source, a stamping air cylinder 4, an air source processor 7 and an object carrier 8, the stamping air cylinder 4 is fixed on the frame 3, a telescopic end of the stamping air cylinder 4 is fixed with a shaping plate 5, the object carrier 8 is located on one side of the telescopic end of the stamping air cylinder 4, the object carrier 8 is fixed relative to the frame 3, the object carrier 8 is provided with a shaping groove 9 corresponding to a position of the shaping plate 5, the stamping air cylinder 4 is connected with the air cylinder control valve 6 through an air pipe, the air cylinder control valve 6 is connected with an output end of the air source processor 7 through an air pipe, an input end of the air source processor 7 is connected with the air source through an air pipe, and the controller 2 is electrically connected with the air cylinder control valve 6 and the air source processor 7 respectively.

Specifically, the step S3 specifically comprises: placing the semi-finished eyelash on the object carrier 8, so that the semi-finished eyelash filaments 34 are located on the shaping groove 9, starting up the stamping air cylinder 4, driving, by the telescopic end of the stamping air cylinder 4, the shaping plate 5 to move towards the shaping groove 9, pressing, by the shaping plate 5, the semi-finished eyelash filaments 34 into the shaping groove 9, after each pressing by the shaping plate 5, driving, by the telescopic end of the stamping air cylinder 4, the shaping plate 5 to retract, moving the semi-finished eyelash filaments 34 in a length direction of the eyelash filaments once, so that a non-pressed part of the semi-finished eyelash filaments 34 is located in the shaping groove 9, driving, by the stamping air cylinder 4, the shaping plate 5 to press again, pressing the non-pressed part of the semi-finished eyelash filaments 34 into the shaping groove 9, and repeating in this way to realize sectional cold stamping of the semi-finished eyelash filaments 34, so that the semi-finished eyelash filaments 34 are bent and shaped. More specifically, when the semi-finished eyelash is cold-stamped, one end of the semi-finished eyelash filaments 34 far away from the semi-finished eyelash stalk 35 is placed on the shaping groove 9 first.

Specifically, one end of the shaping plate 5 close to the object carrier 8 is fixed with a shaping tip 10, one end of the styling tip 10 close to the object carrier 8 is serrated, and the serrated arrangement can realize point pressing on the eyelash filaments, so that a bend molding effect is better. The object carrier 8 and the frame 3 are fixed on the second base 1.

Specifically, a top surface of the object carrier 8 is provided with two slide rails 11, the two slide rails 11 are respectively located at two ends of the shaping groove 9, a length direction of the slide rail 11 is consistent with a moving direction of the semi-finished eyelash filaments 34, a slider 12 is slidably arranged on the slide rail 11, two sliders 12 are fixedly connected with a mounting plate 14, and one end of the mounting plate 14 close to the shaping groove 9 is hinged with a fixing plate 13. During stamping, the fixing plate 13 may be rotated to enable one face of the fixing plate 13 close to the object carrier 8 to be far away from the object carrier 8, the semi-finished eyelash is detachably fixed on one face of the fixing plate 13 close to the object carrier 8, and the semi-finished eyelash filaments 34 are located outside the fixing plate 13. After fixing the semi-finished eyelash, the fixing plate 13 is rotated to enable the fixing plate 13 to be pressed on the object carrier 8, and the semi-finished eyelash is located between the fixing plate 13 and the object carrier 8 at this time. When it is necessary to move the semi-finished eyelash, a staff pushes the fixing plate 13 or the mounting plate 14 to enable the fixing plate 13 to slide along the slide rails 11, thus moving the semi-finished eyelash through the fixing plate 13. When the staff directly holds the semi-finished eyelash for stamping, it is difficult to ensure the stability of movement by manually moving the semi-finished eyelash, a movement path is prone to skew, which affects an effect after shaping, and the staff's hand is easy to touch the stamping air cylinder 4, so that the safety is low. The movement of the semi-finished eyelash by the fixing plate 13 can ensure the stability of movement, thus improving the safety of stamping operation. More specifically, the semi-finished eyelash and the fixing plate 13 may be adhered by an adhesive tape.

Specifically, the pressure plastic shaping device comprises a rolling shaping device, the rolling shaping device comprises a roller 18 and a covering structure, an outer wall of the roller 18 is provided with a plurality of pointed protrusions, the plurality of pointed protrusions cover the outer wall of the roller 18, the pointed protrusions may realize point pressing on the semi-finished eyelash, the semi-finished eyelash is roll-molded by the rolling shaping device, and a roll molding method comprises: wrapping the semi-finished eyelash on the outer wall of the roller 18 by the covering structure, so that the semi-finished eyelash is bent in a circumferential direction of the roller 18, wherein lengths of the semi-finished eyelash filaments 34 are not greater than a circumference of the roller 18, and after wrapping, rolling the roller 18 wrapped with the semi-finished eyelash and the covering structure on a workbench, and pressing the roller 18 while rolling.

Specifically, the rolling shaping device further comprises a first base 23, a support 15 and a first air cylinder 16, the support 15 is fixed on the first base 23, the first air cylinder 16 is fixed on the support 15, a telescopic end of the first air cylinder 16 extends downwards and is fixed with a roller mounting frame 17, two ends of the roller 18 are rotatably connected with the roller mounting frame 17 through a rotating shaft 30, and a space is maintained between an end portion of the roller 18 and the roller mounting frame 17.

A top portion of the roller mounting frame 17 is fixed with a guide rod 24, the guide rod 24 is slidably connected with the support 15, and the stability of movement of the roller mounting frame 17 is improved through the guide rod 24.

The covering structure comprises a semi-cylindrical shell 19, an inner diameter of the semi-cylindrical shell 19 is not less than a diameter of the roller 18, a length of the semi-cylindrical shell 19 is not less than a length of the roller 18, two ends of the semi-cylindrical shell 19 are respectively fixed with a baffle 193, an upper portion of the baffle 193 is provided with a placing groove 25 with a semi-circular bottom end, a radial dimension of the placing groove 25 is the same as a diameter of the rotating shaft 30, and one side of the baffle 193 far away from the semi-cylindrical shell 19 is fixed with an arc-shaped slider 28.

Two ends of the semi-cylindrical shell 19 on the first base 23 are respectively fixed with an elastic telescopic rod 20, a top portion of the elastic telescopic rod 20 is fixed with a semi-circular slide rail 26, and the arc-shaped slider 28 is slidably arranged in the semi-circular slide rail 26. An inner diameter of the semi-circular slide rail 26 is greater than the diameter of the rotating shaft 30, two ends of a top portion of the semi-circular slide rail 26 are fixed with a blocking sheet 27, and the arc-shaped slider 28 is restricted by the blocking sheet 27, so as to avoid the arc-shaped slider 28 from being separated from the semi-circular slide rail 26.

An inner diameter of the arc-shaped slider 28 is the same as the diameter of the rotating shaft 30, and an outer diameter of the arc-shaped slider 28 is the same as the inner diameter of the semi-circular slide rail 26; the arc-shaped slider 28, the semi-circular slide rail 26, the semi-cylindrical shell 19 and a semi-circular end of the placing groove 25 are coaxially arranged, an axis of the semi-cylindrical shell 19 and an axis of the roller 18 are located in a same vertical plane, and the semi-cylindrical shell 19 is located below the roller 18.

A slide plate 21 is slidably arranged on the first base 23, the slide plate 21 is located below the semi-cylindrical shell 19, the slide plate 21 is driven by a second air cylinder 22, and a top surface of the slide plate 21 is the workbench.

The step S3 specifically comprises: placing the semi-finished eyelash in the semi-cylindrical shell 19, starting up the first air cylinder 16, driving, by the first air cylinder 16, the roller 18 to move downwards, so that a lower portion of the roller 18 enters the semi-cylindrical shell 19, allowing the rotating shaft 30 to enter the placing groove 25 and the semi-circular slide rail 26 at the same time, and after the roller 18 and the semi-cylindrical shell 19 are coaxial, wrapping the semi-finished eyelash on the outer wall of the roller 18 under a squeezing action of the roller 18 and the semi-cylindrical shell 19; and continuously driving, by the first air cylinder 16, the roller 18 to move downwards, driving, by the roller 18, the semi-cylindrical shell 19 to move downwards at this time, compressing the elastic telescopic rod 20, after the semi-cylindrical shell 19 makes contact with the top surface of the slide plate 21 and applies a pressure on the slide plate 21 (that is, after the semi-cylindrical shell 19 makes contact with the top surface of the slide plate 21, the telescopic end of the first air cylinder 16 still extends for a certain distance), stopping the first air cylinder 16, starting up the second air cylinder 22, allowing the second air cylinder 22 to repeatedly extend and retract to drive the slide plate 21 to slide back and forth, and driving, by the slide plate 21, the semi-cylindrical shell 19 and the roller 18 to rotate back and forth, so as to realize the rolling pressing on the semi-finished eyelash, so that the semi-finished eyelash filaments 34 are bent and shaped.

Specifically, a bottom portion of the semi-cylindrical shell 19 is made of a heavyweight material 192, such as iron and lead, two sides of the semi-cylindrical shell 19 are made of a lightweight material 191, such as aluminum alloy, the arrangement of the heavyweight material 192 of the bottom portion of the semi-cylindrical shell 19 may ensure that the semi-cylindrical shell 19 will keep its position stable under an action of gravity when the semi-cylindrical shell is idle, thus ensuring that the roller 18 can accurately fall into the semi-cylindrical shell 19 when moving downwards.

More specifically, in order to ensure that the semi-cylindrical shell 19 can better follow the roller 18 to move, a bump may be arranged at a top portion of the arc-shaped slider 28, a groove is arranged in a position corresponding to the bump on the rotating shaft 30, and the bump is inserted into the groove after the roller 18 moves downwards.

Specifically, an inner side of the semi-cylindrical shell 19 is provided with a flexible material layer 29, such as a rubber layer, so as to protect the semi-finished eyelash to a certain extent.

Specifically, the top surface of the slide plate 21 and the outer wall of the semi-cylindrical shell 19 may be set to be rough surfaces, for example, the top surface of the sliding plate 21 and the outer wall of the semi-cylindrical shell 19 are provided with a plurality of protruding points to increase a friction between the top surface of the slide plate 21 and the outer wall of the semi-cylindrical shell 19, so that the slide plate 21 can better drive the semi-cylindrical shell 19 to rotate.

A one-time molded false eyelash is provided, wherein the false eyelash comprises an integrally molded eyelash filament, an eyelash stalk and a grafting post, a plurality of eyelash filaments are provided, the plurality of eyelash filaments are located on one side of the eyelash stalk, the grafting post is located on the other side of the eyelash stalk, and at least two grafting posts are provided.

A wearing method of the one-time molded false eyelash is provided, wherein, when wearing, glue for eyelash grafting is coated on the grafting post and/or the eyelash stalk, then the grafting post and/or the eyelash stalk are adhered to a real eyelash, and the false eyelash is located above or below the real eyelash.

When the grafting posts are provided, the glue may be coated only on the grafting posts, and the grafting posts may be more accurately adhered to a root portion of the real eyelash. Moreover, when the glue is coated only on the grafting posts, an amount of the glue coated is small, which can greatly reduce the irritation to eyes of a wearer, and meanwhile, an adhering duration is longer, which increases a wearing duration, so that the wearer does not need to replace the false eyelash frequently.

Although the embodiments of the present invention have been shown and described, those of ordinary skills in the art may make various changes, modifications, substitutions and variations to these embodiments without departing from the principle and spirit of the present invention, and the scope of the present invention is defined by the appended claims and their equivalents.

We claim:

1. A preparation method of a one-time molded false eyelash, comprising the following steps:
S1: selecting a sheet-shaped film material as a base material, and cutting the base material into filaments according to preset parameters by a laser cutting device to form a single-sheet eyelash or an integrally molded semi-finished eyelash;
S2: when the single-sheet eyelash is formed by cutting, combining and fixing two single-sheet eyelashes to obtain semi-finished products with different styles; and
S3: placing the semi-finished eyelash in a pressure plastic shaping device, and applying a pressure to semi-finished eyelash filaments (34) by the pressure plastic shaping device, so that the semi-finished eyelash filaments (34) are bent and shaped to obtain the false eyelash.

2. The preparation method of the one-time molded false eyelash according to claim 1, wherein the single-sheet eyelash comprises a single-sheet eyelash root connecting stalk (32) and a plurality of single-sheet eyelash filaments (31) which are integrally molded, the single-sheet eyelash filaments (31) are located on one side of the single-sheet eyelash root connecting stalk (32), and the single-sheet eyelash root connecting stalk (32) is straight-shaped, arc-shaped or wave-shaped; and at least two single-sheet grafting posts (33) are arranged on one side of the single-sheet eyelash root connecting stalk (32) far away from the single-sheet eyelash filaments (31), and the single-sheet grafting posts (33) and the single-sheet eyelash root connecting stalk (32) are integrally molded.

3. The preparation method of the one-time molded false eyelash according to claim 1, wherein the pressure plastic shaping device applies the pressure to the semi-finished eyelash filaments (34) by rolling shaping and stamping shaping.

4. The preparation method of the one-time molded false eyelash according to claim 3, wherein the pressure plastic shaping device comprises a stamping shaping device, the stamping shaping device comprises a frame (3), a controller (2), an air cylinder control valve (6), an air source, a stamping air cylinder (4), an air source processor (7) and an object carrier (8), the stamping air cylinder (4) is fixed on the frame (3), a telescopic end of the stamping air cylinder (4) is fixed with a shaping plate (5), the object carrier (8) is located on one side of the telescopic end of the stamping air cylinder (4), the object carrier (8) is fixed relative to the frame (3), the object carrier (8) is provided with a shaping groove (9) corresponding to a position of the shaping plate (5), the stamping air cylinder (4) is connected with the air cylinder control valve (6) through an air pipe, the air cylinder control valve (6) is connected with an output end of the air source processor (7) through an air pipe, an input end of the air source processor (7) is connected with the air source through an air pipe, and the controller (2) is electrically connected with the air cylinder control valve (6) and the air source processor (7) respectively.

5. The preparation method of the one-time molded false eyelash according to claim 4, wherein the step S3 specifically comprises: placing the semi-finished eyelash on the object carrier (8), so that the semi-finished eyelash filaments (34) are located on the shaping groove (9), starting up the stamping air cylinder (4), driving, by the telescopic end of the stamping air cylinder (4), the shaping plate (5) to move towards the shaping groove (9), pressing, by the shaping plate (5), the semi-finished eyelash filaments (34) into the shaping groove (9), after each pressing by the shaping plate (5), driving, by the telescopic end of the stamping air cylinder (4), the shaping plate (5) to retract, moving the semi-finished eyelash filaments (34) in a length direction of the eyelash filaments once, so that a non-pressed part of the semi-finished eyelash filaments (34) is located in the shaping groove (9), driving, by the stamping air cylinder (4), the shaping plate (5) to press again, pressing the non-pressed part of the semi-finished eyelash filaments (34) into the shaping groove (9), and repeating in this way to realize sectional cold stamping of the semi-finished eyelash filaments (34), so that the semi-finished eyelash filaments (34) are bent and shaped.

6. The preparation method of the one-time molded false eyelash according to claim 3, wherein the pressure plastic shaping device comprises a rolling shaping device, the rolling shaping device comprises a roller (18) and a covering structure, an outer wall of the roller (18) is provided with a plurality of pointed protrusions, the plurality of pointed protrusions cover the outer wall of the roller (18), the semi-finished eyelash is roll-molded by the rolling shaping device, and a roll molding method comprises: wrapping the semi-finished eyelash on the outer wall of the roller (18) by the covering structure, so that the semi-finished eyelash is bent in a circumferential direction of the roller (18), and after wrapping, rolling the roller (18) wrapped with the semi-finished eyelash and the covering structure on a workbench, and pressing the roller (18) while rolling.

7. The preparation method of the one-time molded false eyelash according to claim 6, wherein the rolling shaping device further comprises a first base (23), a support (15) and a first air cylinder (16), the support (15) is fixed on the first base (23), the first air cylinder (16) is fixed on the support (15), a telescopic end of the first air cylinder (16) extends downwards and is fixed with a roller mounting frame (17), two ends of the roller (18) are rotatably connected with the roller mounting frame (17) through a rotating shaft (30), and a space is maintained between an end portion of the roller (18) and the roller mounting frame (17);
the covering structure comprises a semi-cylindrical shell (19), the semi-cylindrical shell (19) is located below the roller (18), two ends of the semi-cylindrical shell (19) are respectively fixed with a baffle (193), an upper portion of the baffle (193) is provided with a placing groove (25) with a semi-circular bottom end, and one side of the baffle (193) far away from the semi-cylindrical shell (19) is fixed with an arc-shaped slider (28);
two ends of the semi-cylindrical shell (19) on the first base (23) are respectively fixed with an elastic telescopic rod (20), a top portion of the elastic telescopic rod (20) is fixed with a semi-circular slide rail (26), and the arc-shaped slider (28) is slidably arranged in the semi-circular slide rail (26);
the arc-shaped slider (28), the semi-circular slide rail (26), the semi-cylindrical shell (19) and a semi-circular end of the placing groove (25) are coaxially arranged, an axis of the semi-cylindrical shell (19) and an axis of the roller (18) are located in a same vertical plane, and the semi-cylindrical shell (19) is located below the roller (18); and
a slide plate (21) is slidably arranged on the first base (23), the slide plate (21) is located below the semi-cylindrical shell (19), the slide plate (21) is driven by a second air cylinder (22), and a top surface of the slide plate (21) is the workbench.

8. The preparation method of the one-time molded false eyelash according to claim 7, wherein the step S3 specifically comprises: placing the semi-finished eyelash in the semi-cylindrical shell (19), starting up the first air cylinder (16), driving, by the first air cylinder (16), the roller (18) to move downwards, so that a lower portion of the roller (18) enters the semi-cylindrical shell (19), allowing the rotating shaft (30) to enter the placing groove (25) and the semi-circular slide rail (26) at the same time, and after the roller (18) and the semi-cylindrical shell (19) are coaxial, wrapping the semi-finished eyelash on the outer wall of the roller (18) under a squeezing action of the roller (18) and the semi-cylindrical shell (19); and continuously driving, by the first air cylinder (16), the roller (18) to move downwards, driving, by the roller (18), the semi-cylindrical shell (19) to move downwards at this time, compressing the elastic telescopic rod (20), after the semi-cylindrical shell (19) makes contact with the top surface of the slide plate (21) and applies a pressure on the slide plate (21), stopping the first air cylinder (16), starting up the second air cylinder (22), allowing the second air cylinder (22) to repeatedly extend and retract to drive the slide plate (21) to slide back and forth, and driving, by the slide plate (21), the semi-cylindrical shell (19) and the roller (18) to rotate back and forth, so as to realize the rolling pressing on the semi-finished eyelash, so that the semi-finished eyelash filaments (34) are bent and shaped.

9. A one-time molded false eyelash according to claim 1, wherein the false eyelash comprises an integrally molded eyelash filament, an eyelash stalk and a grafting post, a plurality of eyelash filaments are provided, the plurality of eyelash filaments are located on one side of the eyelash stalk, the grafting post is located on the other side of the eyelash stalk, and at least two grafting posts are provided.

10. A wearing method of the one-time molded false eyelash according to claim 9, wherein, when wearing, glue for eyelash grafting is coated on the grafting post and/or the eyelash stalk, then the grafting post and/or the eyelash stalk are adhered to a real eyelash, and the false eyelash is located above or below the real eyelash.
